(19) United States
(12) Patent Application Publication
(10) Pub. No.: US 2004/0103015 A1
(43) Pub. Date: May 27, 2004

(54) Method and system for production planning

(76) Inventors: Ralf Schaffrath, Stuttgart (DE); Thomas Kotz, Stuttgart (DE); Knut Kille, Stuttgart (DE); Andreas Frede, Gerlingen (DE); Ruediger Herr, Stuttgart (DE)

Correspondence Address: KENYON & KENYON, ONE BROADWAY, NEW YORK, NY, 10004, US

(21) Appl. No.: 10/643,643

(22) Filed: Aug. 18, 2003

(30) Foreign Application Priority Data
Aug. 17, 2002 (DE) 102 377 89.8-53

(51) Int. Cl. G06F 17/60

(52) U.S. Cl. 705/8

(57) ABSTRACT

A method for production planning in which a production planning sequence is subdivided into individual sequence steps. The individual steps are executed one after another and after each sequence step an evaluation is made of a result of the preceding sequence step. A system for performing the method, as well as a computer program and a computer program product are provided.

### FIELD OF THE INVENTION

The present invention relates to a method and a system for production planning as well as a computer program and a computer program product for carrying out the method.

### BACKGROUND INFORMATION

The development of new products may proceed with the development of the production plant and equipment needed for manufacturing the products. In this manner, it may be possible to systematize the planning for manufacturing and assembly beginning in the early phases of product development, and thus to improve it findamentally.

Procedures and methods which support engineers during the development of production plant and equipment are conventional.

U.S. Pat. No. 5,327,340 discusses a method for controlling a production device. In the method, production information in the form of a specified production duration may be made available and in addition a first production estimate value may be calculated.

From that, the calculation may be made of the total number of products to be manufactured in one day. The production machines may be correspondingly controlled, so that the required number may be manufactured. Consequently, the production equipment may be controlled according to requirements.

U.S. Pat. No. 5,278,750 discusses a method for producing a production plan for a process that produces a plurality of products. The products produced are in turn passed on to a plurality of second processes. A production shop floor truck delivery schedule for deliveries and times is used to set up the production plan.

U.S. Pat. No. 4,958,292 relates to a production control system for a mixed production line. In this system, the production control sequence may be planned, taking into consideration the partial transportation times between production stations.

The disadvantages of the aforementioned methods, and also of other conventional methods such as the 6-step method according to REFA, and VDI Guidelines 2221 and 2222, may be that they all treat only partial aspects of a complete planning system, and may therefore not be regarded as continuous and integral methods which are supposed to make possible inclusive planning of ideal and complex production processes.

In addition, the methods may not include any systematic systems for data acquisition, and also may not describe the data required for integral, continuous planning.

### SUMMARY OF THE INVENTION

The production planning method according to an exemplary embodiment of the present invention may provide that a production planning sequence may be subdivided into individual sequence steps, that the individual sequence steps may be carried out one after the other, and that, after each sequence step has occurred, an evaluation or checking of the result of the preceding sequence step may be carried out.

According to an exemplary embodiment of the present invention, the planning sequence may be subdivided into clear steps, which may correspond to the degree of detail involved in each situation. The planning process, which may be dynamic because of many externally and internally changing influential factors that may not be able to be planned, may become controllable and easily comprehensible to the participants. Continuous systematics for the integral planning of ideal and complex production may be established.

The continuous planning systematics may be distinguished by the following elements:

The degree of detailing may be a function of the project progress (separation of essential and nonessential).

A start of each planning step may be possible as early as possible (cooperative engineering).

Current data may be present at all times.

Data management that is free of redundancy may be ensured for interdisciplinary collaboration.

Ideal planning may be a fixed component of the method.

A risk assessment may be carried out.

Evaluation analyses may be provided.

Both a top-down and a bottom-up procedure as well as combinations of these procedural manners may be possible.

Value analysis may be provided.

An analysis may be made of product design suitability for manufacturing and assembly.

Goal-oriented planning may be a given.

A value-added analysis may be provided.

Reduction of complexity may be achieved.

An integration into existing tool and method configurations may be possible.

The method may be applied independent of location.

In its development, the exemplary method according to the present invention may be divided up into the following sequence steps:

1. carrying out a market analysis

2. carrying out a value design process

3. setting up project premises

4. carrying out a product analysis

5. setting up a process chart

6. setting up a structural concept

7. working out a manufacturing concept

8. setting up a rough layout

Individual steps may be run through several times.

In the project premises, a distinction may be made between essential and necessary premises.

Evaluations may be carried out to judge the results of the individual sequence steps. In this context, a static evaluation may be carried out after each sequence step.

In the development of an exemplary embodiment of the present invention, after setting up the rough layout, in addition a dynamic/stochastic evaluation may be performed. This may be referred to as a sequence simulation.

The exemplary method according to the present invention may be carried out tied into a product creation process.

The system according to an exemplary embodiment of the present invention may be used for product planning and particularly for carrying out the exemplary method described above. The exemplary system may have an interface for accommodating user specifications and a processing unit for carrying out evaluations of the results of individual sequence steps.

The computer program according to an exemplary embodiment of the present invention may encompass a program code arrangement in order to perform all the steps of the exemplary method according to the present invention. This may be executed on a computer or an appropriate processing unit.

The computer program product according to an exemplary embodiment of the present invention may include these on a program code medium stored on a computer-readable data carrier. EEPROMs and flash memories, but also CD-ROMs, diskettes and hard disk drives, may be used as suitable data carriers.

### BRIEF DESCRIPTION OF THE DRAWINGS

FIG. 1 schematically depicts an exemplary embodiment of a system according to the present invention.

FIG. 2 shows an exemplary sequence of the exemplary method according to the present invention in a flow diagram.

FIG. 3 shows an example of a possible development of piece counts.

FIG. 4 shows in a flow diagram an exemplary process graph set up according to an exemplary of the present invention.

FIG. 5 shows an exemplary manufacturing concept in a flow diagram.

FIG. 6 shows a utilization diagram.

FIG. 7 illustrates the tying in of the exemplary method according to the present invention into a product development process.

### DETAILED DESCRIPTION

FIG. 1 shows schematically an exemplary embodiment of the system according to the present invention, denoted overall by reference numeral 10. This system 10 has a processing unit 12, a storage device 14 and an interface 16, which are connected to one another by a data line 18.

Interface 16 may be used to accommodate user specifications, which may be entered, for example, on a keyboard. Processing unit 12 may make it possible to carry out the evaluations of the results of individual sequence steps in a production planning process. The data and programs used for this may be filed in memory device 14. A display unit may be expediently provided for visualizing the specifications and the results.

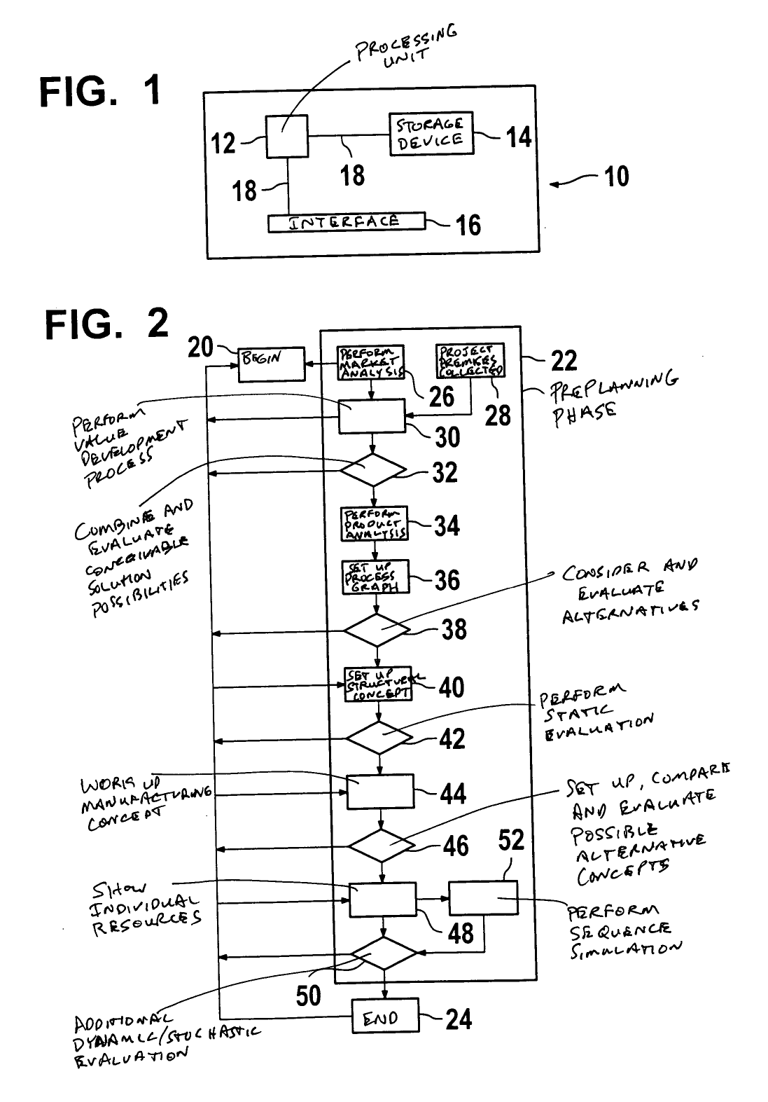

FIG. 2 reflects the methodical sequence of an exemplary method according to the present invention. It should be noted that the sequence steps described below may be executed several times, if needed. Evaluations may be provided in each case to judge the planning results of the individual steps.

The individual sequence steps are described in greater detail below.

At step 20 there begins the development in which results of a preplanning phase marked by a field 22 are used. The procedure ends with a step 24, namely the detailed planning. Subsequently, attention is also paid especially to preplanning phase 22.

In a step 26, market analysis is performed. In the market analysis, sales chances and customer requirements of a planned product may be analyzed, and in this manner the basis for customer-oriented product development may be created. The results of the market analysis as well as sales development, target costs and the technical specifications may be collected in a step 28 as project premises and used for further planning steps.

In a step 30 a value development process may be performed, which may include the partial steps functional analysis, innovation management, morphology and product design. In this context, the functional analysis may convert the customer requirements and the market requirements into detailed functional descriptions of the new product. Using a morphologic box, conceivable solution possibilities may be combined and may be evaluated in a step 32 with respect to their technical and economic implementability.

Individual functions may have cost evaluations applied to them so that one may obtain a basis for the economic efficiency of the planned product. Discarded solutions may be documented, so that, when market requirements change, one may refer back to alternative solution attempts that were previously worked out. The result may be a product design in which the result may be described verbally and using sketches. Product construction may convert these specifications into concrete drawings and models.

The basis of the process variables and machine variables to be established for the production station planning are boundary conditions which may be location-independent and time-independent. These boundary conditions may also be denoted as project premises or just premises.

In the case of the premises, a differentiation may be made between essential premises, which may make a difference for the calculations of machine-relevant results, and necessary premises which have only an informative character. These premises may be used by the manufacturing planner at the same time as a questionnaire as to which data may be necessary for planning.

Essential premises may include:

The time-dependent variable of a shift model and its differently applicable working days per annum is the basis for the time available for production. These shift models are differentiated by different designations or variables. Depending on the location, n shift models may be applied. The shift model may at any time be additionally documented.

An additional variable that is a function of time, which has a substantial influence on production planning is the establishment of piece count development or the technical planning number in a TPZ curve which reflects the quantity of goods to be produced. Risk factors for machines and installations (MAE) and workers may be specified as safety factors as a function of a validity period and of the TPZ curve, in per cent.

A further premise may be the establishment of the compensation groups together with the relevant annual earnings as the basis for determining the pay-related costs. Area costs and area-related costs may be given specifically with respect to area.

Required supply media such as electric current, compressed air, cooling water, etc, may already be established in the premises and may be made available for later calculation having basis prices per units.

Necessary premises may include:

For location description and the available space measurements, for example, area, space height, door width and door height and maximum floor load may be given. To describe the media supply, voltages present, including tolerance, frequency including tolerance and compressed air including tolerance are given. In addition, environmental conditions along with the minimum and maximum actual temperature and the minimum and maximum setpoint temperature and the humidity may be described. These location variables may be additionally documented at any time.

The base planning of the production station may be carried out using a main product. Product variants as subgroups may be described nominally in the premises.

The description of the customer in the premises may be limited to his designation using his delivery location, lead time, delivery quantity, delivery frequency, packaging, release procedure and so-called local content in per cent. For the engineer and the planner, all these variables have reminder characteristics having a purely descriptive dimension. These dimensions may be broadened at any time by specific customer characteristics that are to be described.

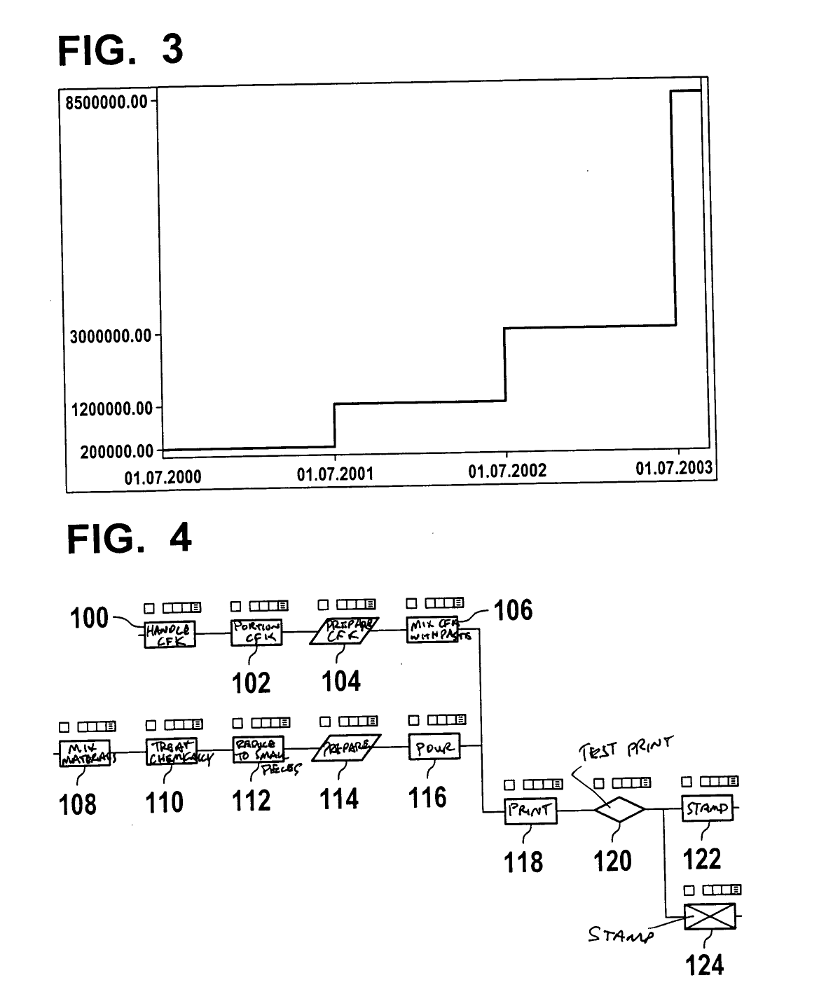

The project may be described on the one hand by its project team and their appropriate responsibilities, and on the other hand by project targets and specifications. Project management per se may not be covered by the integral production preplanning. An example for a possible piece count development is shown in FIG. 3.

During the course of development, important documents may be assigned to any of the premises and found again via a reference.

In a step 34 (FIG. 2) product analysis may be performed, which during product construction may typically be carried out together with the responsible staff members from product planning and development. The product for which manufacturing is to be planned is described in this context. All the component parts and groups may be systematically analyzed with respect to geometry, costs, criteria in regard to manufacturing technology and assembly technology (detachability, positioning, danger of damage, variety of variants, etc) and logistical information (weight, packaging density, rack storability and stackability, etc).

Subsequently, in a step 36, while setting up a process graph, there occurs the specification of the processes that may be necessary for manufacturing the product and assembling it. The processes may be modeled in a flow diagram in correspondence to their sequence. In this context, there may be different types of process, namely, value added processes, non-value added processes (subsidiary processes which are absolutely necessary for manufacturing the part) and the required testing processes.

FIG. 4 shows a process graph, for example. In one value added process 100 there occurs “handle CFK”. In a further value added process 102 there occurs “portion CFK”. Thereupon, in a non-value added process 104, the instruction goes “prepare CFK”. Then, in turn, in a value added process 106, “mix CFK with paste” may be performed.

In parallel with this, in a value added process 108, “mix materials” is performed. In a value added process 110 there then occurs “treat chemically”. There then follows, in a value added process 112, “reduce to small pieces”, in a non-value added process 114 “prepare”, and then in a value added process 116 “pour”.

In a second section there occurs in a value added process 118 “print”, in a testing process 120 “test print” and to close in a value added process 122 “stamp” and a further value added process 124 also “stamp”.

The process graph may be solution-neutral, which means that the question may be deliberately often left open, as to with the aid of which equipment the process is to be implemented. Consequently, the process graph may be valid, independent of location, degree of automation, etc, for different modes of manufacturing.

In this context, each process of the graph may be described using fixedly specified information. Among these are, among others, the process duration (estimated), the process classification (core technology, key technology and standard technology), the process risks and parameters describing the process (for example, required positioning accuracy when joining, or the press-in force).

Alternatives, as for instance with regard to joining sequence or technology, may be considered and may be evaluated in a step 38 (FIG. 2) with regard to value added proportion, process risks, etc.

On the basis of the information obtained in the preceding steps, in a step 40 a structural concept may be set up for the manufacturing to be planned. In this context there may be specified especially the structure of manufacturing and assembly (subdivision of the manufacturing units, lines, etc), the decision as to whether in-house manufacturing is to be used or outside delivery may be preferred, the runup concept, the buffer quantities between manufacturing units, the target cadence signals and the upper limits of capital investment.

In a step 42 there may then be carried out or performed a static evaluation of the results.

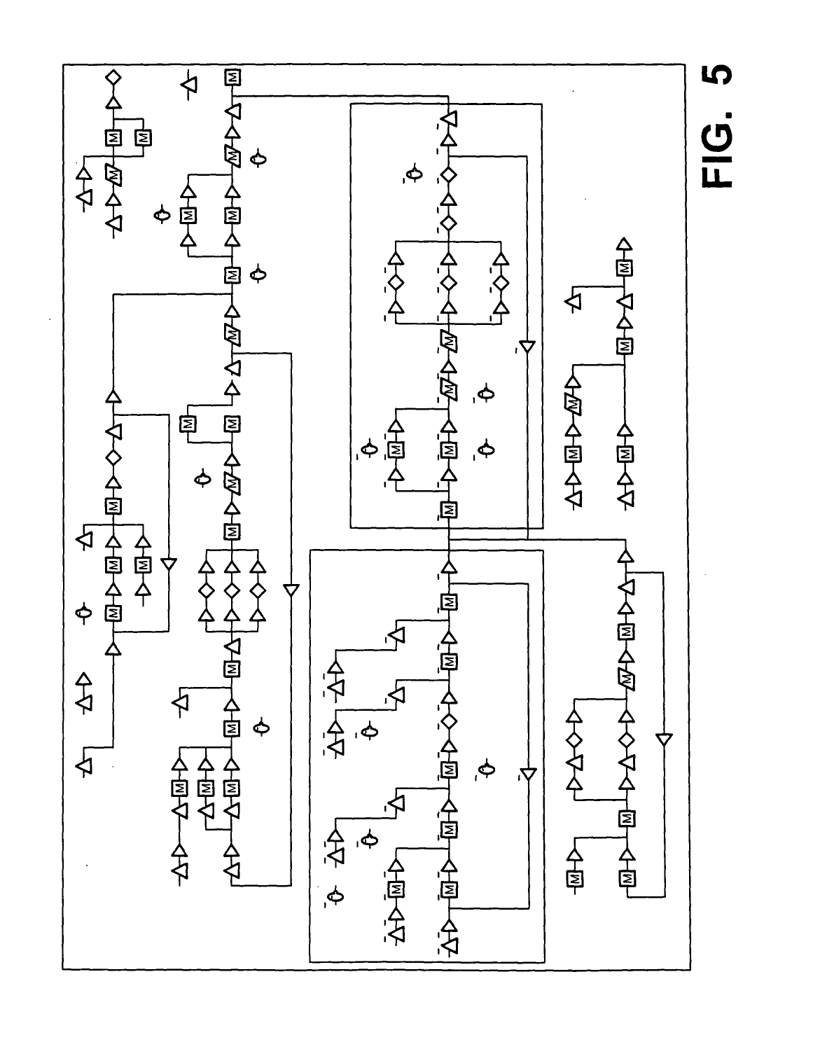

Subsequently, in a step 44, the working up of the manufacturing concept may occur. In this connection, the manufacturing concept may be derived from the process graph while accounting for the specifications of the structure concept. The manufacturing concept may be represented as another flow chart as shown, for example, in FIG. 5, each element symbolizing one resource.

There may be the following types of resource:

machine (creating value added),

machine (not creating value added),

test station,

buffer,

conveyance (interlinked),

conveyance (not interlinked),

conveyance arrangement using a worker.

In this connection, each resource may be planned and described. In addition, it may be established with the use of which machines the processes specified in the process graph are to be executed. Within the scope of this, the following information may be assembled:

working sequence within the station,

machine timing,

capacity utilization of the machine (taking into consideration the piece count development),

costs of the machine (investments and current costs),

dimensions,

media supply,

machine parameters,

machine risks.

In addition, further data may be required for the interlinked conveyances:

description of the work piece carrier,

belt dimension and speed.

The types of resource in the buffer, the conveyance (not interlinked) and the means of transport arrangement may be used for logistics planning. For these, for each component part and each assembly, among other things, the auxiliary transport arrangement and the transport path may be specified. The results may be such as transportation expenditure and/or the frequency of delivery, and consequently the requirement for operational equipment.

Furthermore, the use of personnel may be planned, each position capable of being described by a series of informational items such as qualification, work content, shift model, etc.

The data of the individual resources may be aggregated, so that the manufacturing concept may be evaluated from various points of view, such as investment, use of personnel, process risks and quality risks, supply usage, transportation expenditure and costs, as well as utilization of the installation, etc.

Furthermore, possible alternative concepts (various piece count scenarios, degrees of automation, locations, etc) may be set up, compared to one another and evaluated in a step 46. The result may be a block diagram having all the sequences and appertaining data sheets describing the individual resources.

The results may be compared to the target specifications, such as the ones from the structural concept.

In a step 48, after the working up and selection of the manufacturing concept, the individual resources may be shown in a rough layout corresponding to their dimensions specified in the manufacturing concept. In this context, the resources may be integrated into an existing hall layout and moved, until the desired layout is achieved. Here too, various layout variants may be generated from one manufacturing concept.

Each resource from the manufacturing concept may be replaced by a corresponding layout element. Various graphic elements, which may be variable in size, may be defined for representing the resources used. These elements are:

manual work place,

automatic station,

robot station,

rotary table,

belt pieces,

machining center,

supply,

crates,

skeleton containers,

shelves,

employees,

control cabinet,

additional geometrical base plates.

The elements may of course be arranged and substituted as desired. During the course of further planning (detailed planning) these resources may be then put step by step in more concrete terms.

In a step 50 there may then ensue an additional dynamic/stochastic evaluation of the rough layout, in the light of a sequence simulation performed in step 52. This may support the safeguarding or optimization of the planning result (investment, capacity, etc). For this purpose, a simulation model may be generated from the rough layout as well as from the data obtained in the manufacturing concept. The prerequisites for this is a statement of the simulation-relevant parameters, such as scrap quota, down time, buffer volumes, etc. From the results of the sequence simulation, for example, the down times and waiting times of the individual stations, important inferences may be drawn with respect to possible bottleneck stations.

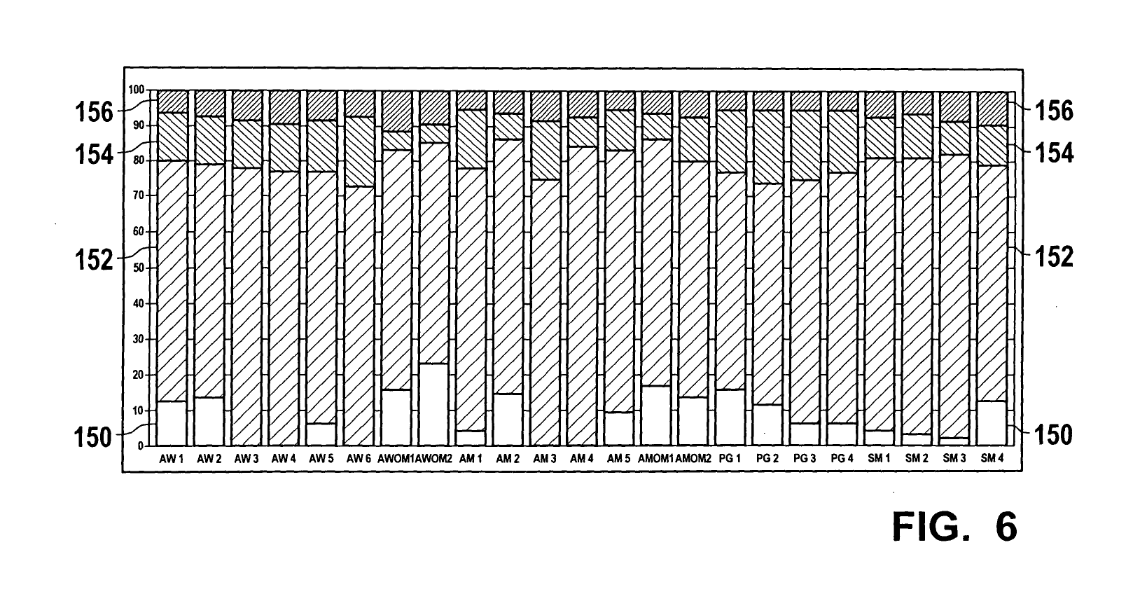

A utilization diagram is given as an example in FIG. 6. In it, a first area 150 denotes “no orders”, a second area 152 “working”, a third area 154 “down time” and a fourth area 156 “set up”.

After setting up the project premises and carrying out the product analysis, the actual planning may begin with the preparation of the process graph. An evaluation may be made after each step is finished, namely, either a comparison and the selection of the best alternatives or an adjustment to target specifications. In the case of non-fulfillment, possibly one or several steps have to be run through again. This may also be true in case of clear changes of the premises or design changes in the product.

Thus, the individual steps may follow one another sequentially, but recursive loops may also be required. The adoption of the functions graph, the process graph, the structural concept, the manufacturing concept and the rough layout may represent essential points in the planning cycle.

The result of preplanning may be a full scale layout of the manufacturing structure having the description of all resources included in it and various estimates valid for the entire manufacturing concept. The estimates for the entire manufacturing concept may be:

MAE investments, differentiated by one-time and recurring costs,

human resources estimate, differentiated by direct and indirect labor with corresponding position costs,

supply usage estimate, differentiated by average usage and annual costs,

area requirement estimate.

The resources data may form the basis for the detailed planning and may be passed on to the respective positions, namely, operational equipment construction and operational equipment procurement. The estimates may be the basis for the investment decisions and the project computation of the planning.

The knowledge obtained within the scope of preplanning may be passed on to operational equipment construction, operational systems planning and/or logistics planning. Thus, the planning may be put in concrete terms step by step.

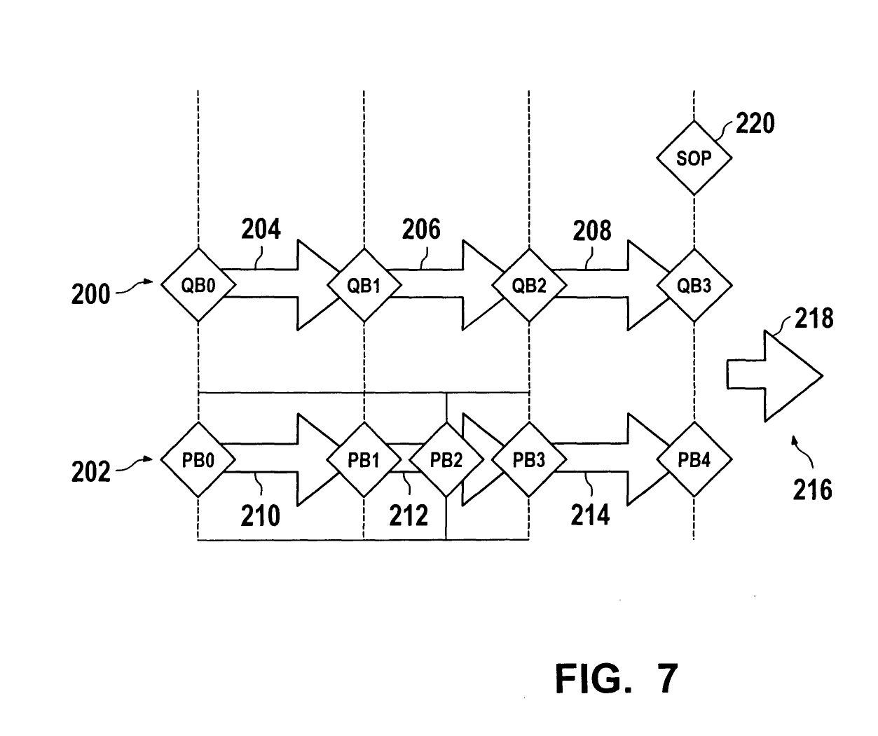

FIG. 7 shows the linking of preplanning into the product development process. Production preplanning may occur in parallel with product development. Consequently, the influencing control on product design from a point of view of manufacturing technology and assembly techniques may be ensured.

Product development occurs in a first sequence 200, and parallel to it, production development in a second sequence 202.

Product specifications may be generated within the scope of product development in a first step 204. Then, in an additional step 206 the so-called B sample may be made. Manufacturing of the C sample and the EZ release may then be performed in a step 208.

Parallel to this, in a step 210, preplanning may be carried out, in a step 212 the detailed planning, and in a step 214 the virtual mass production may start.

Finally, in a step 216, production may begin with a mass runup 218 and mass production start 220.

What is claimed is:

1. A method for production planning, comprising:
subdividing a production planning sequence into individual sequence steps;
executing each of the individual sequence steps one after another; and
evaluating, after each of the individual sequence steps, a result of a preceding one of the individual sequence steps.

2. The method of claim 1, further comprising: executing repeatedly each of the individual sequence steps if necessary.

3. The method of claim 1, wherein the evaluating of the result of the preceding individual sequence step includes performing a static evaluation.

4. The method of claim 1, wherein the individual sequence steps includes:
performing a market analysis;
executing a value design process;
setting up project premises;
performing a product analysis;
setting up a process graph;
setting up a structural concept;
working out a manufacturing concept; and
setting up a rough layout.

5. The method of claim 4, wherein the project premises include essential project premises and necessary project premises.

6. The method of claim 4, further comprising: performing an additional evaluation after setting up the rough layout.

7. The method of claim 6, wherein the performing of the additional evaluation is performed as a dynamic and stochastic evaluation.

8. The method of claim 1, wherein the method is performed and linked into a product development process.

9. A system for production planning, comprising:
an interface adapted to accommodate user specifications; and
a processing unit adapted to perform evaluations of results of individual sequence steps;
wherein a production planning sequence is subdivided into the individual sequence steps;
wherein each of the individual sequence steps is executed one after another; and
wherein, after each of the individual sequence steps, the processing unit evaluates a result of a preceding one of the individual sequence steps.

10. A computer program, comprising:
a program code arrangement executable on one of a computer and a corresponding processing arrangement to perform the following:
subdividing a production planning sequence into individual sequence steps;
executing each of the individual sequence steps one after another; and
evaluating, after each of the individual sequence steps, a result of a preceding one of the individual sequence steps.

11. The computer program of claim 10, wherein the corresponding processing arrangement includes an electronic processing arrangement in a system.

12. A computer program product, comprising:
a program code arrangement stored on a computer-readable data medium, and being executable on one of a computer and a corresponding processing arrangement to perform the following:
subdividing a production planning sequence into individual sequence steps;
executing each of the individual sequence steps one after another; and
evaluating, after each of the individual sequence steps, a result of a preceding one of the individual sequence steps.

13. The computer program product of claim 12, wherein the corresponding processing arrangement includes an electronic processing arrangement in a system.
